(19) United States
(12) Patent Application Publication
(10) Pub. No.: US 2024/0239014 A1
(43) Pub. Date: Jul. 18, 2024

(54) CHUTE FOR A MIXER VEHICLE

(71) Applicant: Oshkosh Corporation, Oshkosh, WI (US)

(72) Inventors: Jarud Hoefker, Oshkosh, WI (US); Clint Glunz, Rochester, MN (US)

(73) Assignee: Oshkosh Corporation, Oshkosh, WI (US)

(21) Appl. No.: 18/414,056

(22) Filed: Jan. 16, 2024

Related U.S. Application Data
(60) Provisional application No. 63/439,774, filed on Jan. 18, 2023.

(51) Int. Cl. B28C 5/42

(52) U.S. Cl. CPC B28C 5/4237

(57) ABSTRACT

A hopper for a mixer vehicle includes a body defining a flat medial surface for transfer of material into a mixer drum of the mixer vehicle. The flat medial surface is angled 45 degrees or less relative to a vertical axis.

### CROSS-REFERENCE TO RELATED PATENT APPLICATION

This application claims the benefit of and priority to U.S. Provisional Application No. 63/439,774, filed Jan. 18, 2023, the entire disclosure of which is incorporated by reference herein.

### BACKGROUND

Concrete mixer vehicles are configured to receive, mix, and transport wet concrete or a combination of ingredients that when mixed form wet concrete to a job site. Concrete mixer vehicles include a rotatable mixer drum that mixes the concrete disposed therein.

### SUMMARY

One embodiment of the present disclosure is a hopper for a mixer vehicle. The hopper includes a body defining a flat medial surface for transfer of material into a mixer drum of the mixer vehicle. The flat medial surface is angled 45 degrees or less relative to a vertical axis.

In some embodiments, the hopper includes a front plate. The front plate extends vertically along the vertical axis. The body extends rearward from the front plate and the flat medial surface extends downwards and forwards past the front plate. In some embodiments, the body has a U-shape having multiple discrete flat surfaces.

In some embodiments, the hopper includes a bottom plate. The bottom plate is positioned at an end of the flat medial surface. A transition between the flat medial surface and the bottom plate is forwards of the front plate. In some embodiments, the bottom plate is oriented at an angle of at least 20 degrees relative to the flat medial surface. In some embodiments, the bottom plate is manufactured from a material includes a nominal hardness of at least 400 Brinell Hardness Number. In some embodiments, the body further includes an accessory bar positioned on an exterior surface of the body on a side of the body opposite the front plate. The accessory bar includes multiple light emitting devices or a camera.

Another embodiment of the present disclosure is a mixer vehicle. The mixer vehicle includes a chassis, a mixer assembly, and a hopper. The mixer assembly is coupled with the chassis. The mixer assembly includes a mixer drum. The hopper is configured to direct material into the mixer drum. The hopper includes a body defining a flat medial surface for transfer of material into the mixer drum of the mixer vehicle. The flat medial surface is angled 45 degrees or less relative to a vertical axis.

In some embodiments, the hopper further includes a front plate. The front plate extends vertically along the vertical axis. The body extends rearward from the front plate and the flat medial surface extends downwards and forwards past the front plate. In some embodiments, the body has a U-shape including multiple discrete flat surfaces. In some embodiments, the hopper further includes a bottom plate. The bottom plate is positioned at an end of the flat medial surface. A transition between the flat medial surface and the bottom plate is forwards of the front plate. In some embodiments, the bottom plate is oriented at an angle of at least 20 degrees relative to the flat medial surface.

In some embodiments, the bottom plate is manufactured from a material having a nominal hardness of at least 400 Brinell Hardness Number. In some embodiments, the body further includes an accessory bar positioned on an exterior surface of the body on a side of the body opposite the front plate. The accessory bar includes multiple light emitting devices or a camera.

Another embodiment of the present disclosure is a hopper for a mixer vehicle. The hopper includes a body and a front plate. The body defines a flat medial surface for transfer of material into a mixer drum of the mixer vehicle. The flat medial surface is angled 45 degrees or less relative to a vertical axis. The front plate extends vertically along the vertical axis. The body extends rearward from the front plate and the flat medial surface extends downwards and forwards past the front plate.

In some embodiments, the body has a U-shape including multiple discrete flat surfaces. In some embodiments, the hopper also includes a bottom plate. The bottom plate is positioned at an end of the flat medial surface. A transition between the flat medial surface and the bottom plate is forwards of the front plate.

In some embodiments, the bottom plate is oriented at an angle of at least 20 degrees relative to the flat medial surface. In some embodiments, the bottom plate is manufactured from a material comprising a nominal hardness of at least 400 Brinell Hardness Number.

In some embodiments, the body further includes an accessory bar positioned on an exterior surface of the body on a side of the body opposite the front plate. The accessory bar includes multiple light emitting devices or a camera.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a side view of a concrete mixer truck with a drum assembly and a control system, according to an exemplary embodiment;

FIG. 2 is a detailed side view of the drum assembly of the concrete mixer truck of FIG. 1, according to an exemplary embodiment;

FIG. 3 is a schematic diagram of a drum drive system of the concrete mixer truck of FIG. 1, according to an exemplary embodiment;

FIG. 4 is a power flow diagram for the concrete mixer truck of FIG. 1 having a drum drive system that is selectively coupled to a transmission with a clutch, according to an exemplary embodiment;

FIG. 5 is a schematic diagram of a drum drive system of the concrete mixer truck of FIG. 1, according to another exemplary embodiment;

FIG. 6 is a perspective view of a chute for the mixer vehicle of FIG. 1, according to an exemplary embodiment;

FIG. 7 is a front view of the chute of FIG. 6, according to an exemplary embodiment;

FIG. 8 is a perspective view of a chute for the mixer vehicle of FIG. 1 including two sections, according to an exemplary embodiment;

FIG. 9 is a front view of the chute of FIG. 8, according to an exemplary embodiment;

FIG. 10 is a side view of the chute of FIG. 8, according to an exemplary embodiment;

FIG. 11 is a rear perspective view of the chute of FIG. 8, according to an exemplary embodiment;

FIG. 12 is a perspective view of a chute for the mixer vehicle of FIG. 1, according to an exemplary embodiment;

FIG. 13 is a side view of the chute for the mixer vehicle of FIG. 1, according to an exemplary embodiment;

FIG. 14 is a side view of the chute for the mixer vehicle of FIG. 1, according to an exemplary embodiment;

FIG. 15 is a perspective view of the chute installed on the mixer vehicle of FIG. 1, according to an exemplary embodiment;

FIG. 16 is a rear view of the chute installed on the mixer vehicle of FIG. 1, according to an exemplary embodiment; and

FIG. 17 is a rear perspective view of the chute installed on the mixer vehicle of FIG. 1, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

Referring generally to the FIGURES, a chute (e.g., a hopper) for a mixer vehicle includes a body, a front plate, and a bottom plate. The body extends rearwards from the front plate in a U-shape having multiple discrete sections. The multiple discrete sections may be flat faces that extend downwards and forwards, past the front plate. The multiple discrete sections may extend inwardly towards each other to result in a converging body for charging of a mixer drum. The discrete sections may be angled 45 degrees relative to a vertical axis. The bottom plate may be welded or coupled onto a bottom edge of the discrete sections. The bottom plate may be angled 23 degrees relative to one of the discrete sections. Advantageously, the chute provides improved angles of the components relative to each other and a widened throat compared to other chutes.

### Mixer Vehicle

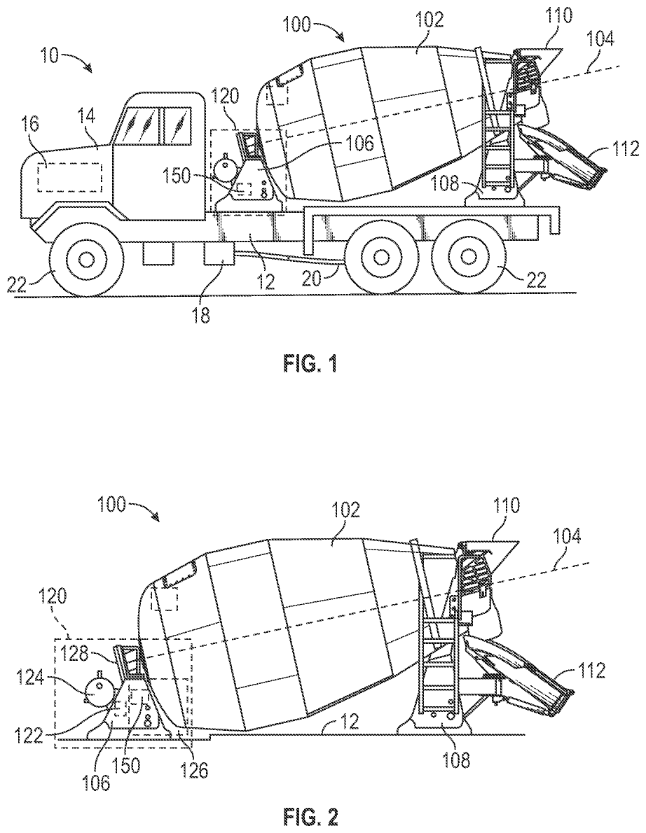

According to the exemplary embodiment shown in FIGS. 1-5, a vehicle, shown as concrete mixer truck 10, includes a drum assembly, shown as drum assembly 100, and a control system, shown as drum control system 150. According to an exemplary embodiment, the concrete mixer truck 10 is configured as a rear-discharge concrete mixer truck. In other embodiments, the concrete mixer truck 10 is configured as a front-discharge concrete mixer truck. As shown in FIG. 1, the concrete mixer truck 10 includes a chassis, shown as frame 12, and a cab, shown as cab 14, coupled to the frame 12 (e.g., at a front end thereof, etc.). The drum assembly 100 is coupled to the frame 12 and disposed behind the cab 14 (e.g., at a rear end thereof, etc.), according to the exemplary embodiment shown in FIG. 1. In other embodiments, at least a portion of the drum assembly 100 extends in front of the cab 14. The cab 14 may include various components to facilitate operation of the concrete mixer truck 10 by an operator (e.g., a seat, a steering wheel, hydraulic controls, a user interface, switches, buttons, dials, etc.).

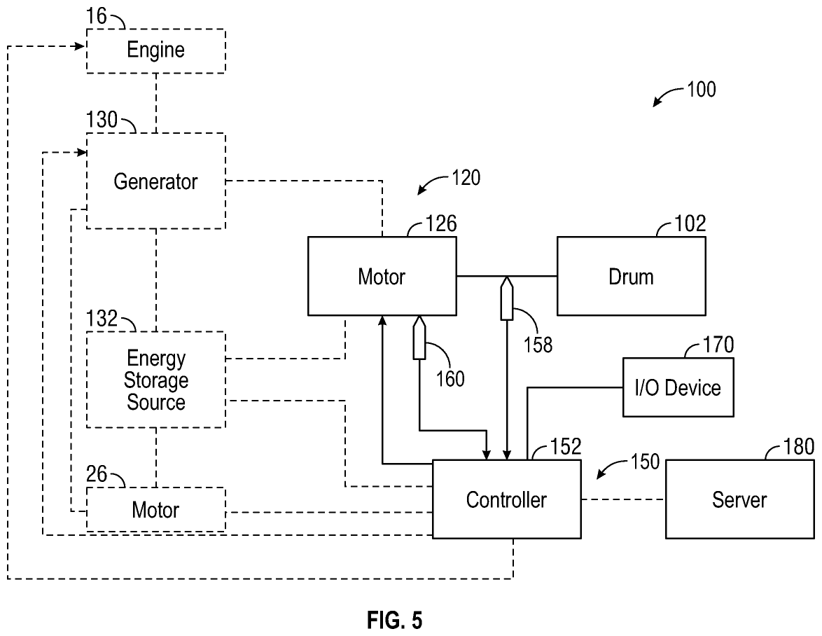

As shown in FIGS. 1, 3, and 4, the concrete mixer truck 10 includes a prime mover, shown as engine 16. As shown in FIG. 1, the engine 16 is coupled to the frame 12 at a position beneath the cab 14. The engine 16 may be configured to utilize one or more of a variety of fuels (e.g., gasoline, diesel, bio-diesel, ethanol, natural gas, etc.), according to various exemplary embodiments. According to an alternative embodiment, as shown in FIG. 5 and described in more detail herein, the prime mover additionally or alternatively includes one or more electric motors and/or generators, which may be coupled to the frame 12 (e.g., a hybrid vehicle, an electric vehicle, etc.). The electric motors may consume electrical power from an on-board storage device (e.g., batteries, ultra-capacitors, etc.), from an on-board generator (e.g., an internal combustion engine, a genset, etc.), and/or from an external power source (e.g., overhead power lines, etc.) and provide power to systems of the concrete mixer truck 10.

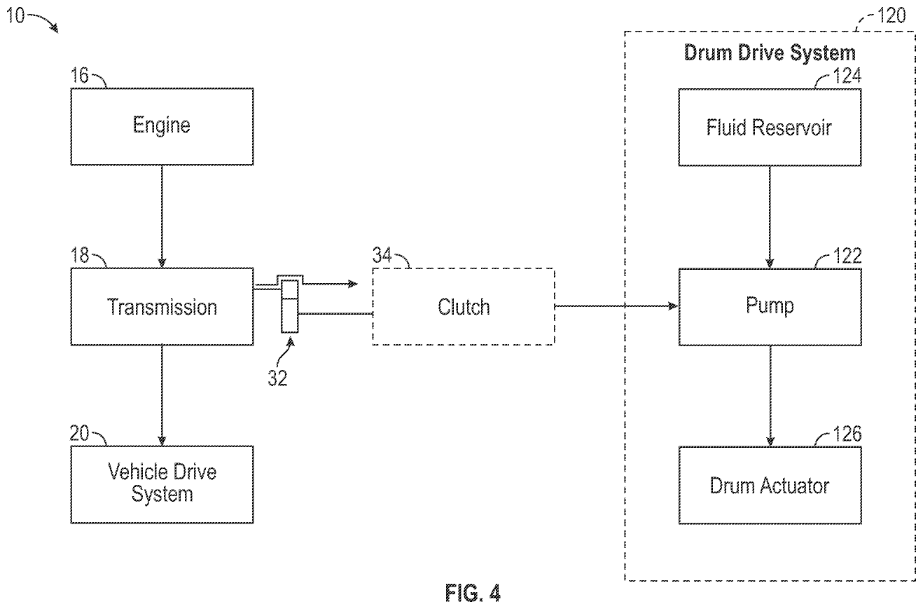

As shown in FIGS. 1 and 4, the concrete mixer truck 10 includes a power transfer device, shown as transmission 18. In one embodiment, the engine 16 produces mechanical power (e.g., due to a combustion reaction, etc.) that flows into the transmission 18. As shown in FIGS. 1 and 4, the concrete mixer truck 10 includes a first drive system, shown as vehicle drive system 20, that is coupled to the transmission 18. The vehicle drive system 20 may include drive shafts, differentials, and other components coupling the transmission 18 with a ground surface to move the concrete mixer truck 10. As shown in FIG. 1, the concrete mixer truck 10 includes a plurality of tractive elements, shown as wheels 22, that engage a ground surface to move the concrete mixer truck 10. In one embodiment, at least a portion of the mechanical power produced by the engine 16 flows through the transmission 18 and into the vehicle drive system 20 to power at least a portion of the wheels 22 (e.g., front wheels, rear wheels, etc.). In one embodiment, energy (e.g., mechanical energy, etc.) flows along a first power path defined from the engine 16, through the transmission 18, and to the vehicle drive system 20.

As shown in FIGS. 1-3 and 5, the drum assembly 100 of the concrete mixer truck 10 includes a drum, shown as mixer drum 102. The mixer drum 102 is coupled to the frame 12 and disposed behind the cab 14 (e.g., at a rear and/or middle of the frame 12, etc.). As shown in FIGS. 1-5, the drum assembly 100 includes a second drive system, shown as drum drive system 120, that is coupled to the frame 12. As shown in FIGS. 1 and 2, the concrete mixer truck 10 includes a first support, shown as front pedestal 106, and a second support, shown as rear pedestal 108. According to an exemplary embodiment, the front pedestal 106 and the rear pedestal 108 cooperatively couple (e.g., attach, secure, etc.) the mixer drum 102 to the frame 12 and facilitate rotation of the mixer drum 102 relative to the frame 12. In an alternative embodiment, the drum assembly 100 is configured as a stand-alone mixer drum that is not coupled (e.g., fixed, attached, etc.) to a vehicle. In such an embodiment, the drum assembly 100 may be mounted to a stand-alone frame. The stand-alone frame may be a chassis including wheels that assist with the positioning of the stand-alone mixer drum on a worksite. Such a stand-alone mixer drum may also be detachably coupled to and/or capable of being loaded onto a vehicle such that the stand-alone mixer drum may be transported by the vehicle.

As shown in FIGS. 1 and 2, the mixer drum 102 defines a central, longitudinal axis, shown as axis 104. According to an exemplary embodiment, the drum drive system 120 is configured to selectively rotate the mixer drum 102 about the axis 104. As shown in FIGS. 1 and 2, the axis 104 is angled relative to the frame 12 such that the axis 104 intersects with the frame 12. According to an exemplary embodiment, the axis 104 is elevated from the frame 12 at an angle in the range of five degrees to twenty degrees. In other embodiments, the axis 104 is elevated by less than five degrees (e.g., four degrees, three degrees, etc.) or greater than twenty degrees (e.g., twenty-five degrees, thirty degrees, etc.). In an alternative embodiment, the concrete mixer truck 10 includes an actuator positioned to facilitate selectively adjusting the axis 104 to a desired or target angle (e.g., manually in response to an operator input/command, automatically according to a control scheme, etc.).

As shown in FIGS. 1 and 2, the mixer drum 102 of the drum assembly 100 includes an inlet, shown as hopper 110, and an outlet, shown as chute 112. According to an exemplary embodiment, the mixer drum 102 is configured to receive a mixture, such as a concrete mixture (e.g., cementitious material, aggregate, sand, etc.), with the hopper 110. The mixer drum 102 may include a mixing element (e.g., fins, etc.) positioned within the interior thereof. The mixing element may be configured to (i) agitate the contents of mixture within the mixer drum 102 when the mixer drum 102 is rotated by the drum drive system 120 in a first direction (e.g., counterclockwise, clockwise, etc.) and (ii) drive the mixture within the mixer drum 102 out through the chute 112 when the mixer drum 102 is rotated by the drum drive system 120 in an opposing second direction (e.g., clockwise, counterclockwise, etc.).

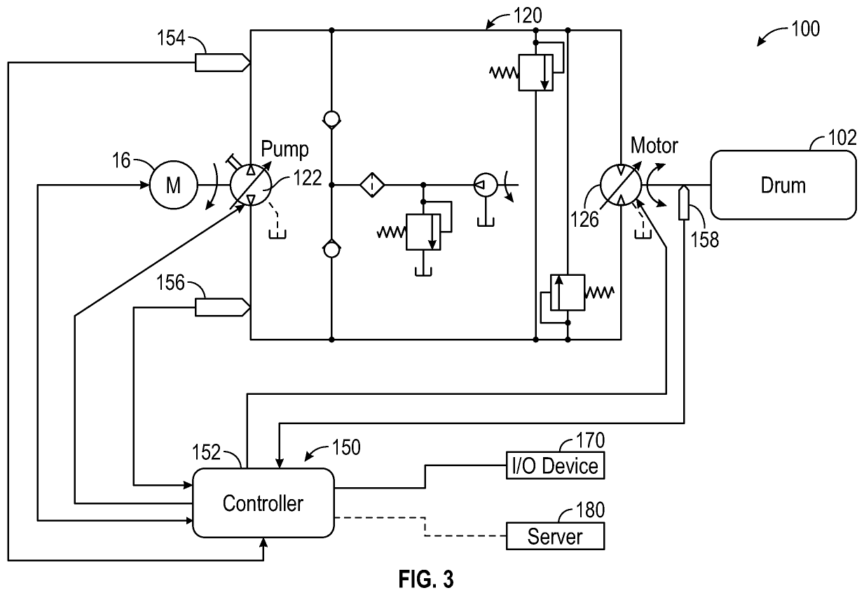

According to the exemplary embodiment shown in FIGS. 2-4, the drum drive system is a hydraulic drum drive system. As shown in FIGS. 2-4, the drum drive system 120 includes a pump, shown as pump 122; a reservoir, shown as fluid reservoir 124, fluidly coupled to the pump 122; and an actuator, shown as drum motor 126. As shown in FIGS. 3 and 4, the pump 122 and the drum motor 126 are fluidly coupled. According to an exemplary embodiment, the drum motor 126 is a hydraulic motor, the fluid reservoir 124 is a hydraulic fluid reservoir, and the pump 122 is a hydraulic pump. The pump 122 may be configured to pump fluid (e.g., hydraulic fluid, etc.) stored within the fluid reservoir 124 to drive the drum motor 126.

According to an exemplary embodiment, the pump 122 is a variable displacement hydraulic pump (e.g., an axial piston pump, etc.) and has a pump stroke that is variable. The pump 122 may be configured to provide hydraulic fluid at a flow rate that varies based on the pump stroke (e.g., the greater the pump stroke, the greater the flow rate provided to the drum motor 126, etc.). The pressure of the hydraulic fluid provided by the pump 122 may also increase in response to an increase in pump stroke (e.g., where pressure may be directly related to work load, higher flow may result in higher pressure, etc.). The pressure of the hydraulic fluid provided by the pump 122 may alternatively not increase in response to an increase in pump stroke (e.g., in instances where there is little or no work load, etc.). The pump 122 may include a throttling element (e.g., a swash plate, etc.). The pump stroke of the pump 122 may vary based on the orientation of the throttling element. In one embodiment, the pump stroke of the pump 122 varies based on an angle of the throttling element (e.g., relative to an axis along which the pistons move within the axial piston pump, etc.). By way of example, the pump stroke may be zero where the angle of the throttling element is equal to zero. The pump stroke may increase as the angle of the throttling element increases. According to an exemplary embodiment, the variable pump stroke of the pump 122 provides a variable speed range of up to about 10:1. In other embodiments, the pump 122 is configured to provide a different speed range (e.g., greater than 10:1, less than 10:1, etc.).

In one embodiment, the throttling element of the pump 122 is movable between a stroked position (e.g., a maximum stroke position, a partially stroked position, etc.) and a destroked position (e.g., a minimum stroke position, a partially destroked position, etc.). According to an exemplary embodiment, an actuator is coupled to the throttling element of the pump 122. The actuator may be positioned to move the throttling element between the stroked position and the destroked position. In some embodiments, the pump 122 is configured to provide no flow, with the throttling element in a non-stroked position, in a default condition (e.g., in response to not receiving a stroke command, etc.). The throttling element may be biased into the non-stroked position. In some embodiments, the drum control system 150 is configured to provide a first command signal. In response to receiving the first command signal, the pump 122 (e.g., the throttling element by the actuator thereof, etc.) may be selectively reconfigured into a first stroke position (e.g., stroke in one direction, a destroked position, etc.). In some embodiments, the drum control system 150 is configured to additionally or alternatively provide a second command signal. In response to receiving the second command signal, the pump 122 (e.g., the throttling element by the actuator thereof, etc.) may be selectively reconfigured into a second stroke position (e.g., stroke in an opposing second direction, a stroked position, etc.). The pump stroke may be related to the position of the throttling element and/or the actuator.

According to another exemplary embodiment, a valve is positioned to facilitate movement of the throttling element between the stroked position and the destroked position. In one embodiment, the valve includes a resilient member (e.g., a spring, etc.) configured to bias the throttling element in the destroked position (e.g., by biasing movable elements of the valve into positions where a hydraulic circuit actuates the throttling element into the destroked positions, etc.). Pressure from fluid flowing through the pump 122 may overcome the resilient member to actuate the throttling element into the stroked position (e.g., by actuating movable elements of the valve into positions where a hydraulic circuit actuates the throttling element into the stroked position, etc.).

As shown in FIG. 4, the concrete mixer truck 10 includes a power takeoff unit, shown as power takeoff unit 32, that is coupled to the transmission 18. In another embodiment, the power takeoff unit 32 is coupled directly to the engine 16. In one embodiment, the transmission 18 and the power takeoff unit 32 include mating gears that are in meshing engagement. A portion of the energy provided to the transmission 18 flows through the mating gears and into the power takeoff unit 32, according to an exemplary embodiment. In one embodiment, the mating gears have the same effective diameter. In other embodiments, at least one of the mating gears has a larger diameter, thereby providing a gear reduction or a torque multiplication and increasing or decreasing the gear speed.

As shown in FIG. 4, the power takeoff unit 32 is selectively coupled to the pump 122 with a clutch 34. In other embodiments, the power takeoff unit 32 is directly coupled to the pump 122 (e.g., without clutch 34, etc.). In some embodiments, the concrete mixer truck 10 does not include the clutch 34. By way of example, the power takeoff unit 32 may be directly coupled to the pump 122 (e.g., a direct configuration, a non-clutched configuration, etc.). According to an alternative embodiment, the power takeoff unit 32 includes the clutch 34 (e.g., a hot shift PTO, etc.). In one embodiment, the clutch 34 includes a plurality of clutch discs. When the clutch 34 is engaged, an actuator forces the plurality of clutch discs into contact with one another, which couples an output of the transmission 18 with the pump 122. In one embodiment, the actuator includes a solenoid that is electronically actuated according to a clutch control strategy. When the clutch 34 is disengaged, the pump 122 is not coupled to (i.e., is isolated from) the output of the transmission 18. Relative movement between the clutch discs or movement between the clutch discs and another component of the power takeoff unit 32 may be used to decouple the pump 122 from the transmission 18.

In one embodiment, energy flows along a second power path defined from the engine 16, through the transmission 18 and the power takeoff unit 32, and into the pump 122 when the clutch 34 is engaged. When the clutch 34 is disengaged, energy flows from the engine 16, through the transmission 18, and into the power takeoff unit 32. The clutch 34 selectively couples the pump 122 to the engine 16, according to an exemplary embodiment. In one embodiment, energy along the first flow path is used to drive the wheels 22 of the concrete mixer truck 10, and energy along the second flow path is used to operate the drum drive system 120 (e.g., power the pump 122, etc.). By way of example, the clutch 34 may be engaged such that energy flows along the second flow path when the pump 122 is used to provide hydraulic fluid to the drum motor 126. When the pump 122 is not used to drive the mixer drum 102 (e.g., when the mixer drum 102 is empty, etc.), the clutch 34 may be selectively disengaged, thereby conserving energy. In embodiments without clutch 34, the mixer drum 102 may continue turning (e.g., at low speed) when empty.

The drum motor 126 is positioned to drive the rotation of the mixer drum 102. In some embodiments, the drum motor 126 is a fixed displacement motor. In some embodiments, the drum motor 126 is a variable displacement motor. In one embodiment, the drum motor 126 operates within a variable speed range up to about 3:1 or 4:1. In other embodiments, the drum motor 126 is configured to provide a different speed range (e.g., greater than 4:1, less than 3:1, etc.). According to an exemplary embodiment, the speed range of the drum drive system 120 is the product of the speed range of the pump 122 and the speed range of the drum motor 126. The drum drive system 120 having a variable pump 122 and a variable drum motor 126 may thereby have a speed range that reaches up to 30:1 or 40:1 (e.g., without having to operate the engine 16 at a high idle condition, etc.). According to an exemplary embodiment, increased speed range of the drum drive system 120 having a variable displacement motor and a variable displacement pump relative to a drum drive system having a fixed displacement motor frees up boundary limits for the engine 16, the pump 122, and the drum motor 126. Advantageously, with the increased capacity of the drum drive system 120, the engine 16 does not have to run at either high idle or low idle during the various operating modes of the drum assembly 100 (e.g., mixing mode, discharging mode, filling mode, etc.), but rather the engine 16 may be operated at a speed that provides the most fuel efficiency and most stable torque. Also, the pump 122 and the drum motor 126 may not have to be operated at displacement extremes to meet the speed requirements for the mixer drum 102 during various applications, but can rather be modulated to the most efficient working conditions (e.g., by the drum control system 150, etc.).

As shown in FIG. 2, the drum drive system 120 includes a drive mechanism, shown as drum drive wheel 128, coupled to the mixer drum 102. The drum drive wheel 128 may be welded, bolted, or otherwise secured to the head of the mixer drum 102. The center of the drum drive wheel 128 may be positioned along the axis 104 such that the drum drive wheel 128 rotates about the axis 104. According to an exemplary embodiment, the drum motor 126 is coupled to the drum drive wheel 128 (e.g., with a belt, a chain, a gearing arrangement, etc.) to facilitate driving the drum drive wheel 128 and thereby rotate the mixer drum 102. The drum drive wheel 128 may be or include a sprocket, a cogged wheel, a grooved wheel, a smooth-sided wheel, a sheave, a pulley, or still another member. In other embodiments, the drum drive system 120 does not include the drum drive wheel 128. By way of example, the drum drive system 120 may include a gearbox that couples the drum motor 126 to the mixer drum 102. By way of another example, the drum motor 126 (e.g., an output thereof, etc.) may be directly coupled to the mixer drum 102 (e.g., along the axis 104, etc.) to rotate the mixer drum 102.

According to the exemplary embodiment shown in FIG. 5, the drum drive system 120 of the drum assembly 100 is configured to be an electric drum drive system. As shown in FIG. 5, the drum drive system 120 includes the drum motor 126, which is electrically powered to drive the mixer drum 102. By way of example, in an embodiment where the concrete mixer truck 10 has a hybrid powertrain, the engine 16 may drive a generator (e.g., with the power takeoff unit 32, etc.), shown as generator 130, to generate electrical power that is (i) stored for future use by the drum motor 126 in storage (e.g., battery cells, etc.), shown as energy storage source 132, and/or (ii) provided directly to drum motor 126 to drive the mixer drum 102. The energy storage source 132 may additionally be chargeable using a mains power connection (e.g., through a charging station, etc.). By way of another example, in an embodiment where the concrete mixer truck 10 has an electric powertrain, the engine 16 may be replaced with a main motor, shown as primary motor 26, that drives the wheels 22. The primary motor 26 and the drum motor 126 may be powered by the energy storage source 132 and/or the generator 130 (e.g., a regenerative braking system, etc.).

According to the exemplary embodiments shown in FIGS. 3 and 5, the drum control system 150 for the drum assembly 100 of the concrete mixer truck 10 includes a controller, shown as drum assembly controller 152. In one embodiment, the drum assembly controller 152 is configured to selectively engage, selectively disengage, control, and/or otherwise communicate with components of the drum assembly 100 and/or the concrete mixer truck 10 (e.g., actively control the components thereof, etc.). As shown in FIGS. 3 and 5, the drum assembly controller 152 is coupled to the engine 16, the primary motor 26, the pump 122, the drum motor 126, the generator 130, the energy storage source 132, a pressure sensor 154, a temperature sensor 156, a speed sensor 158, a motor sensor 160, an input/output (“I/O”) device 170, and/or a remote server 180. In other embodiments, the drum assembly controller 152 is coupled to more or fewer components. By way of example, the drum assembly controller 152 may send and/or receive signals with the engine 16, the primary motor 26, the pump 122, the drum motor 126, the generator 130, the energy storage source 132, the pressure sensor 154, the temperature sensor 156, the speed sensor 158, the motor sensor 160, the I/O device 170, and/or the remote server 180.

The drum assembly controller 152 may be implemented as hydraulic controls, a general-purpose processor, an application specific integrated circuit (ASIC), one or more field programmable gate arrays (FPGAs), a digital-signal-processor (DSP), circuits containing one or more processing components, circuitry for supporting a microprocessor, a group of processing components, or other suitable electronic processing components. According to an exemplary embodiment, the drum assembly controller 152 includes a processing circuit having a processor and a memory. The processing circuit may include an ASIC, one or more FPGAs, a DSP, circuits containing one or more processing components, circuitry for supporting a microprocessor, a group of processing components, or other suitable electronic processing components. In some embodiments, the processor is configured to execute computer code stored in the memory to facilitate the activities described herein. The memory may be any volatile or non-volatile computer-readable storage medium capable of storing data or computer code relating to the activities described herein. According to an exemplary embodiment, the memory includes computer code modules (e.g., executable code, object code, source code, script code, machine code, etc.) configured for execution by the processor.

According to an exemplary embodiment, the drum assembly controller 152 is configured to facilitate detecting the buildup of concrete within the mixer drum 102. By way of example, over time after various concrete discharge cycles, concrete may begin to build up and harden within the mixer drum 102. Such buildup is disadvantageous because of the increased weight of the concrete mixer truck 10 and decreased charge capacity of the mixer drum 102. Such factors may reduce the efficiency of concrete delivery. Therefore, the concrete that has built up must be cleaned from the interior of the mixer drum 102 (i.e., using a chipping process). Typically, the buildup is monitored either (i) manually by the operator of the concrete mixer truck 10 (e.g., by inspecting the interior of the mixer drum 102, etc.) or (ii) using expensive load cells to detect a change in mass of the mixer drum 102 when empty. According to an exemplary embodiment, the drum assembly controller 152 is configured to automatically detect concrete buildup within the mixer drum 102 using sensor measurements from more cost effective sensors and processes.

### Charging Chute

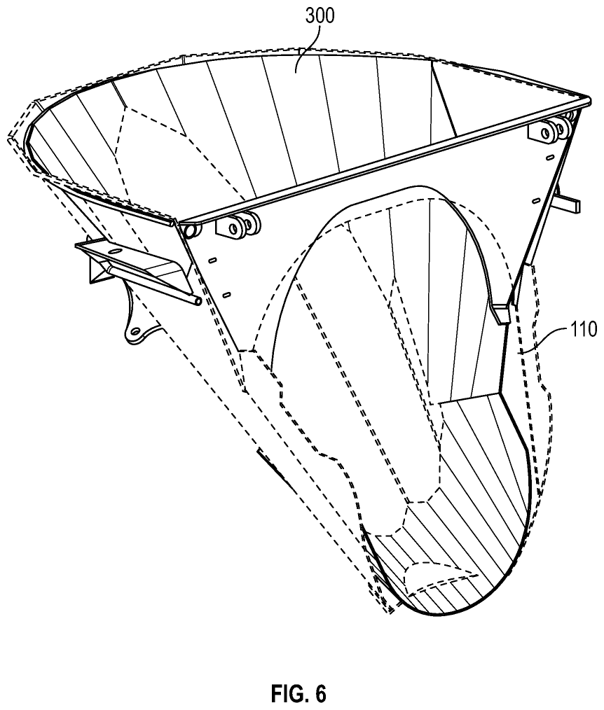

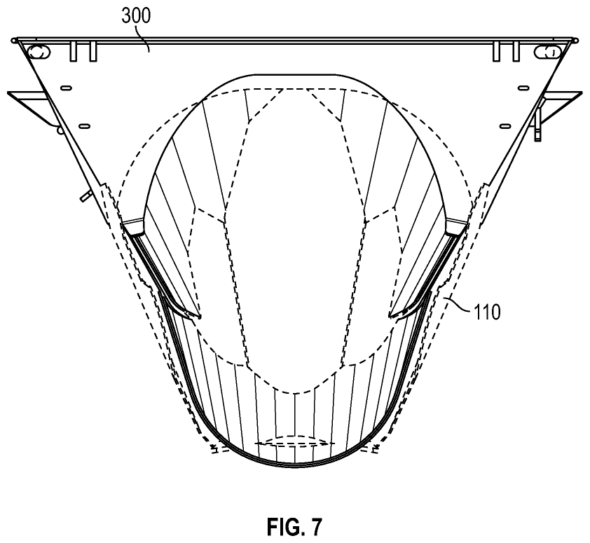

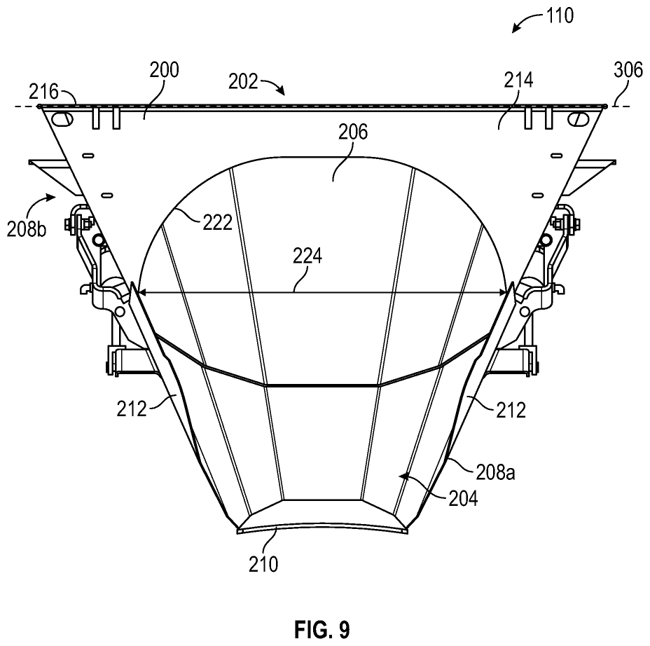

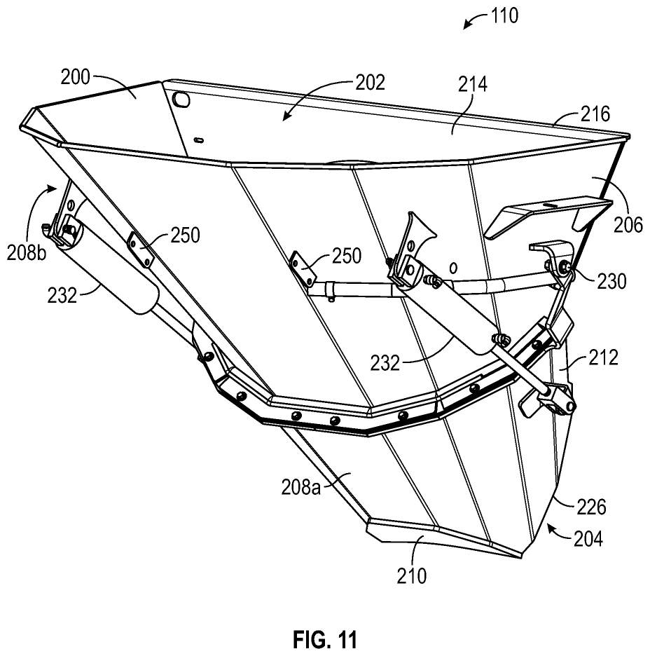

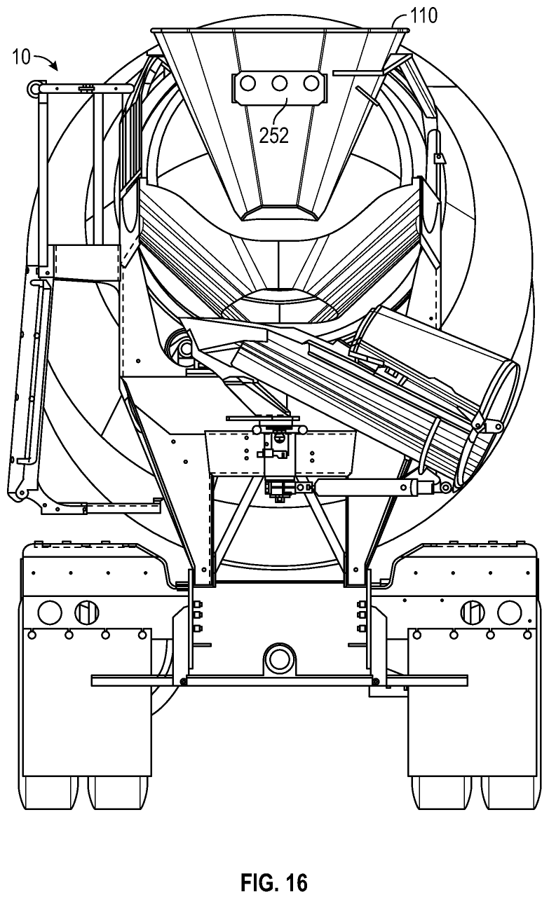

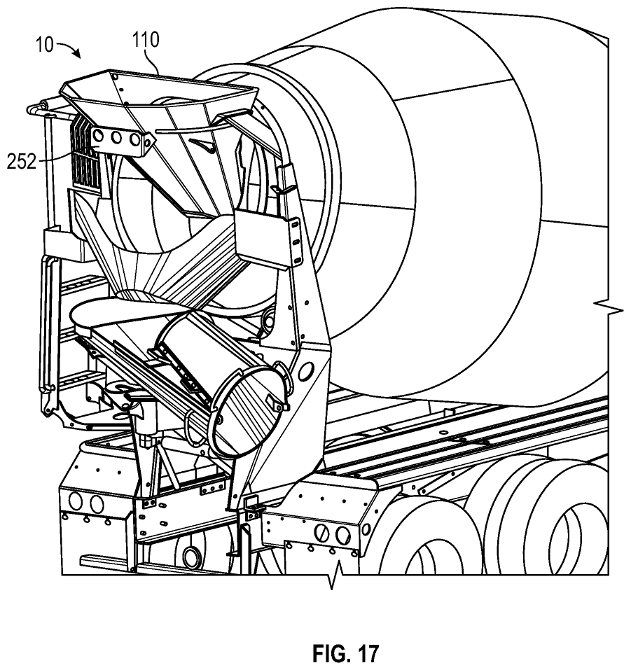

Referring to FIGS. 6-17, the hopper 110 includes a body 200 (e.g., a shell), a plate 214 (e.g., a planar member, support member, a structural member, etc.), a rim 216 (e.g., a lip), and a bottom plate 210. In some embodiments, the hopper 110 defines an inlet 202 and an outlet 204. The rim 216 and the plate 214 are oriented perpendicularly or normal to each other, such that the rim 216 extends rearwards from a top portion or top edge of the plate 214. The body 200 defines one or more angled surfaces that extend from the rim 216 to the bottom plate 210 in order to guide material into the mixer drum 102 (e.g., using gravity). The angled surfaces of the body 200 may decrease in width from the rim 216 to the bottom plate 210 such that a cross-sectional flow area of the body 200 decreases from the rim 216 to the bottom plate 210. In some embodiments, the rim 216 and the bottom plate 210 have a perimeter along one or more portions that is the same or similar, with the bottom plate 210 being overall smaller than the rim 216.

The plate 214 may include or define a vertical axis 302 (e.g., defining an upwards and downwards direction), and a lateral axis 306. The lateral axis 306 may define a left and right direction of the hopper 110. The rim 216 may extend in a rearwards direction from an upper edge of the plate 214 along a longitudinal axis 304. In some embodiments, the longitudinal axis 304 defines a forwards and rearwards direction.

The body 200 extends from the rim 216 in a downwards and frontwards direction to thereby define the one or more angled surfaces for guiding material into the mixer drum 102. The one or more angled surfaces may have a constant slope along an entire length of the body 200 until the body 200 meets and terminates at the bottom plate 210. In some embodiments, the body 200 extends from a position rearwards of the plate 214 (e.g., along the axis 304) and terminates at a position past or in front of the plate 214 (e.g., at the transition between the body 200 and the bottom plate 210). A portion of the rim 216 that extends rearwardly from the plate 214 may have a U-shape, extending from a first top corner of the plate 214 to a second top corner of the plate 214. In some embodiments, the rim 216 is formed from multiple discrete sections 220. In particular, the rim 216 includes first sections 220a that extend perpendicularly from the plate 214, first angled sections 220b that are angled relative to the first sections 220a, second angled sections 220c that are angled relative to the first angled sections 220b, and medial section 220d. In some embodiments, the medial section 220d extends in a direction parallel with the lateral axis 306. In some embodiments, the first section 220a extend in directions parallel with the longitudinal axis 304. The bottom plate 210 can also include one or more edges, peripheries, or boundaries that correspond with the first sections 220a of the rim 216. For example, the bottom plate 210 may include a medial edge corresponding to the medial section 220d, a first pair of angled edges extending from the medial edge and corresponding to the second angled sections 220c, and a second pair of angled edges extending from the first pair of angled edges and corresponding to the first angled sections 220b.

The body 200 may be formed from multiple panels 206 that correspond with and extend from (e.g., in a direction partially downwards, partially forwards, and inwards) the sections 220 of the rim 216. For example, the body 200 may include a first pair of panels 206a that extend from the first sections 220a along outer edges of the plate 214 (e.g., in an inwards or converging direction towards each other), a second pair of panels 206b that extend from first angled sections 220b, a third pair of panels 206c that extend from second angled sections 220c, and a medial panel 206d that extends from the medial section 220d. In some embodiments, the panels 206 each have a constant or unchanging slope along their lengths. In some embodiments, the medial panel 206d extends from the medial section 220d to the medial edge of the bottom plate 210 (e.g., in a downwards and forwards direction from the medial section 220d that is positioned rearwards of the plate 214. The panels 206 of the body 200 may be integrally formed with each other. In some embodiments, the body 200 is manufactured by folding or bending a sheet of material so as to result in the surfaces illustrated by the panels 206.

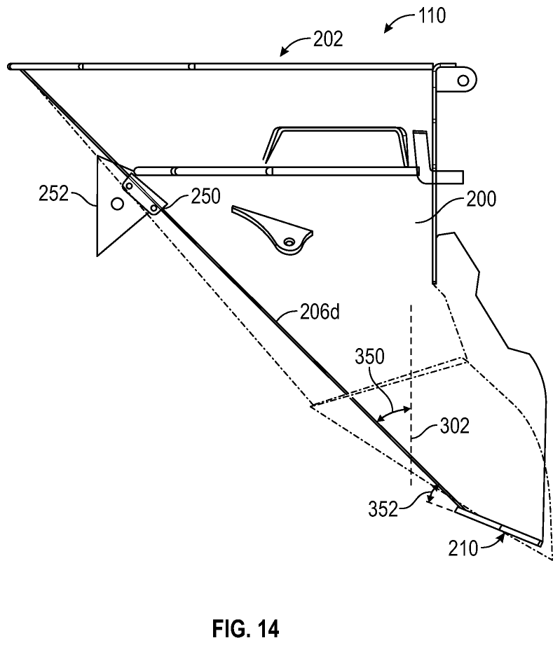

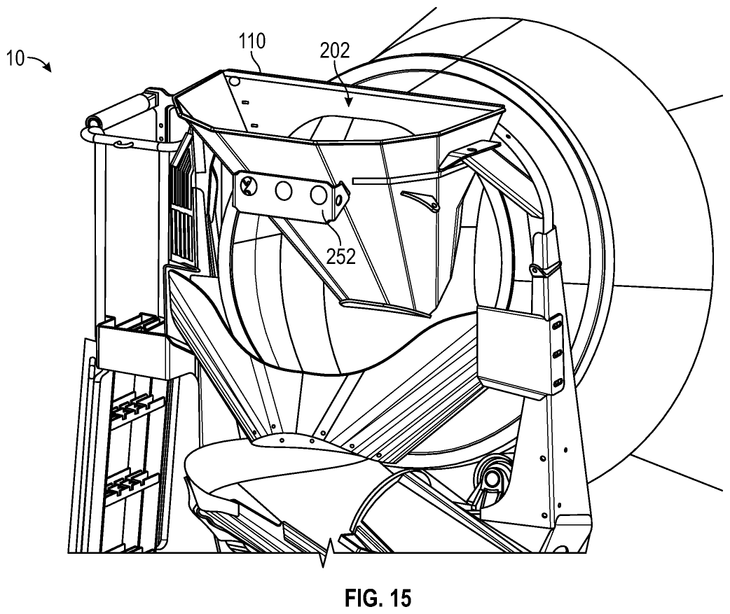

Referring to FIG. 14, the medial panel 206d may form an angle 350 with the vertical axis 302. In some embodiments, the angle 350 between the medial panel 206d and the vertical axis 302 (or an axis parallel with the vertical axis 302) is 45 degrees. In some embodiments, the angle 350 is less than 45 degrees (e.g., 42 degrees). In some embodiments, the angle 350 is between 40 degrees and 45 degrees. The angle 350 of the medial panel 206d advantageously facilitates improved guidance and discharge of materials (e.g., slurry materials, additives, etc.) into the mixer drum 102. In some embodiments, the bottom plate 210 is also angled relative to the vertical axis 302. The bottom plate 210 can be oriented at an angle 352 relative to the medial panel 206d. In some embodiments, the angle 352 is 23 degrees. In some embodiments, the angle 352 is 20 degrees or greater.

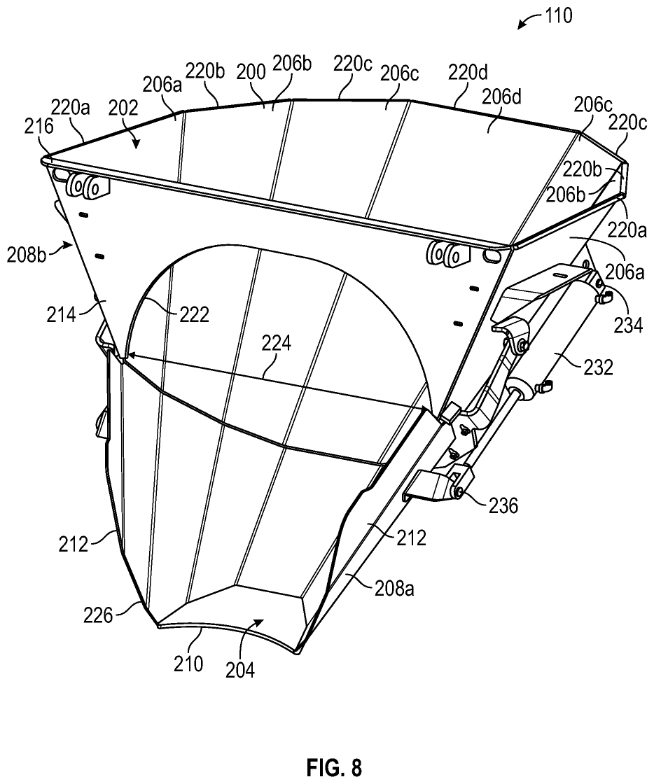

Referring again to FIGS. 8-14, the bottom plate 210 may be manufactured from a high abrasion resistant material (e.g., an AR 400 steel or any other material having a nominal hardness of at least 400 Brinell Hardness Number (BNH)). In some embodiments, the bottom plate 210 (e.g., a kicker plate) is welded onto the body 200 (e.g., ends of the panels 206). In some embodiments, the bottom plate 210 is manufactured from a thicker material or a material with higher structural strength than the body 200. In some embodiments, the orientation and size of the bottom plate 210 relative to the body 200 (e.g., the angular offset and relative size of the body 200 and the bottom plate 210) results in facilitating targeting increased wear conditions of bottom plate 210 than the body 200 by the material travelling through the hopper 110. Targeting increased wear conditions on the bottom plate 210 instead of the body 200 is advantageous because the bottom plate 210 is manufactured to be more wear resistant than the body 200. This allows the body 200 to be manufactured from a lighter material which reduces overall weight of the hopper 110. Advantageously, the body 200 may be manufactured from a thinner, lighter weight material and can be manufactured by bending a sheet of the material (thereby allowing the hopper 110 to be manufactured by manufacturers that only have a bender or bending machine without requiring special rolling machines).

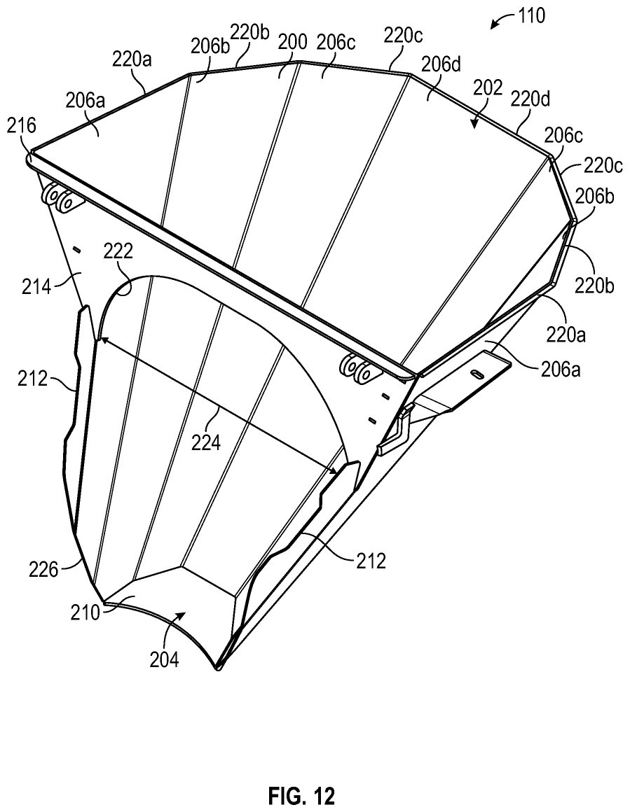

Referring still to FIGS. 8-14, the body 200 generally has the form of a funnel with substantially flat or constantly sloped surfaces. The body 200 directs material from the inlet 202 into the mixer drum 102 through the outlet 204. As shown in FIGS. 8 and 12, the medial panel 206d extends from the medial section 220d of the rim 216, and terminates at the corresponding medial edge of the bottom plate 210. The third pair of panels 206c extends from the second angled sections 220c of the rim 216 to the corresponding angled edges of the bottom plate 210. The second pair of panels 206b extend from the first angled sections 220b and terminate at edges of the bottom plate 210 that is perpendicular with the medial edge. The first pair of panels 206a extend from the first sections 220a and terminate at an edge 226 of the body 200. The hopper 110 also includes splash guards 212 (e.g., lips, edges, planar surfaces, angled surfaces, etc.) that extend from an edge of the first pair of panels 206a that is downwards and forwards of the plate 214.

Referring to FIGS. 8-9 and 12, the plate 214 includes a cut-out, an opening, a window, etc., shown as aperture 222. The aperture 222 facilitates improved width of a throat of the hopper 110 to improve flow of the material through the hopper 110. The hopper 110 can have a throat width 224 that decreases along a flow path of the hopper 110 to thereby result in a converging shape of the hopper 110. In some embodiments, the splash guards 212 and the throat of the hopper 110 facilitate directing or funneling material towards a center of the mixer drum 101 and reduce a likelihood of material splashing over the sides of the body 200.

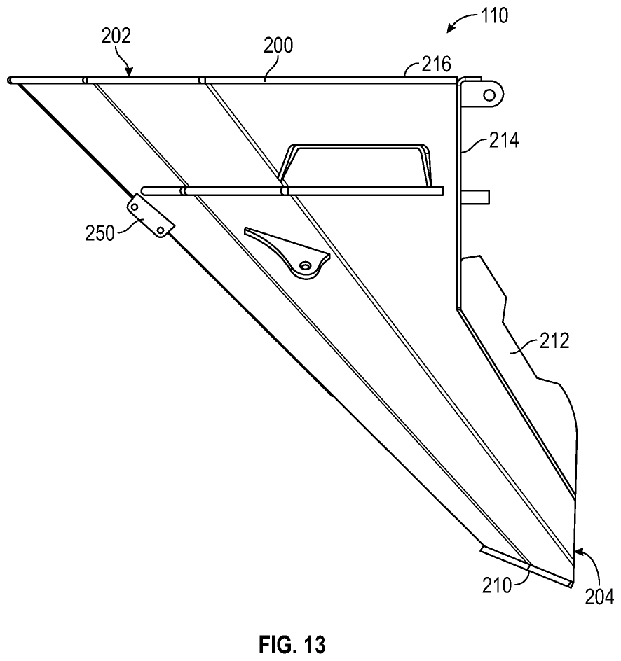

Referring particularly to FIGS. 12-13, the hopper 110 can be provided as an integral unit (e.g., a solid unit) that is coupled onto the concrete mixer truck 10. In some embodiments, the panels 206 are continuous members that form the body 200.

Referring particularly to FIGS. 8-11, the hopper 110 can be provided as a two-unit assembly including a lower member 208a and an upper member 208b. The upper member 208b includes the plate 214, the rim 216, and an upper half of the body 200, up to the bottom of the plate 214. The lower member 208a includes a lower half of the body 200, the splash guards 212, and the bottom plate 210. The lower member 208a can be hingedly coupled with the upper member 208b via hinge 230. In some embodiments, the hopper 110 also includes actuators 232 that pivotally couple with the upper member 208b at a first end 234 and pivotally couple with the lower member 208a at a second end 236. The actuators 232 can extend or retract to drive the lower member 208a to pivot about the hinge 230 relative to the upper member 208b.

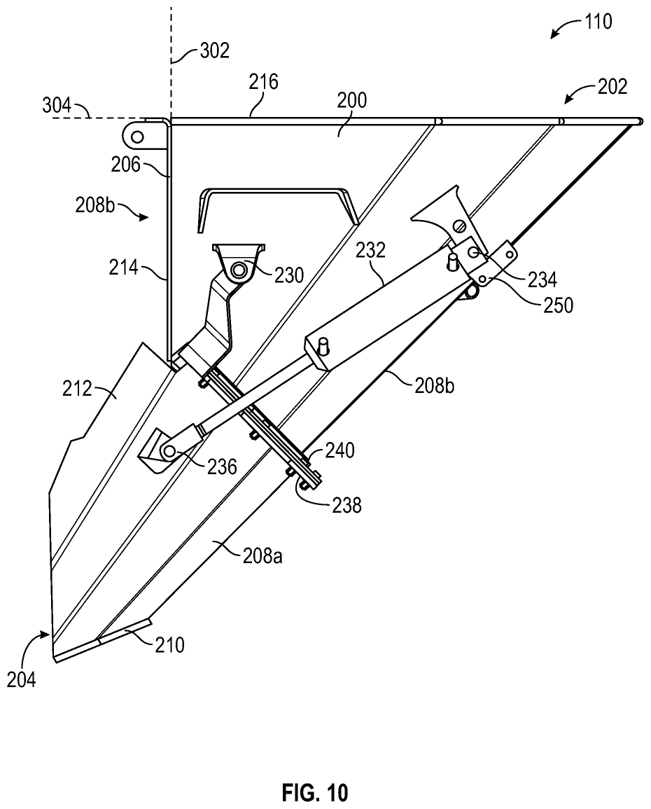

Referring particularly to FIG. 10, the lower member 208a includes a flange 238 and the upper member 208b includes a flange 240. The flanges 238 and 240 may be positioned at corresponding ends of the lower member 208a and the upper member 208b such that the flanges 238 and 240 are driven into engagement when the actuators 232 retract. The flanges 238 and 240 can include seals that are configured to engage each other when the actuators 232 retract and drive the flanges 238 and 240 into engagement with each other.

Referring to FIGS. 10, 11, and 13-17, the hopper 110 may include one or more mounts 250 positioned on an outer surface of the body 200 (e.g., on a side of the body 200 opposite the plate 214) for receiving an accessory bar 252. The accessory bar 252 can include one or more lights (e.g., light emitting diodes), speakers, blinkers, flashers, reflective materials, cameras, etc., to provide improved conspicuity of the concrete mixer truck 10. In some embodiments, the mounts 250 (e.g., flanges, protrusions, interlocking members, etc.) are welded onto an outer surface of the body 200 and configured to couple the accessory bar 252 (e.g., a light bar) onto the hopper 110. In some embodiments, the accessory bar 252 includes multiple openings for coupling one or more accessories onto the accessory bar 252.

Referring to FIGS. 6-7, the hopper 110 is shown, compared to a hopper 300 manufactured by a roller apparatus. As shown in FIG. 6, the hopper 110 includes a longer and straighter flow surface, with the knee between the bottom plate 210 and the body 200 being positioned lower along the flow surface than the hopper 300. The hopper 110 also includes a wider throat which facilitates improved speed of flow of the material along the hopper 110.

The present disclosure contemplates methods, systems and program products on memory or other machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products or memory comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. Combinations of the above are also included within the scope of machine-readable media. Machine-executable instructions include, by way of example, instructions and data which cause a general purpose computer, special purpose computer, or special purpose processing machines to perform a certain function or group of functions.

As utilized herein, the terms “approximately”, “about”, “substantially”, and similar terms are intended to have a broad meaning in harmony with the common and accepted usage by those of ordinary skill in the art to which the subject matter of this disclosure pertains. It should be understood by those of skill in the art who review this disclosure that these terms are intended to allow a description of certain features described and claimed without restricting the scope of these features to the precise numerical ranges provided. Accordingly, these terms should be interpreted as indicating that insubstantial or inconsequential modifications or alterations of the subject matter described and claimed are considered to be within the scope of the invention as recited in the appended claims.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” etc.) are merely used to describe the orientation of various elements in the figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the elements of the systems and methods as shown in the exemplary embodiments are illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

1. A hopper for a mixer vehicle, the hopper comprising:
a body defining a flat medial surface for transfer of material into a mixer drum of the mixer vehicle, the flat medial surface being angled 45 degrees or less relative to a vertical axis.

2. The hopper of claim 1, further comprising a front plate, the front plate extending vertically along the vertical axis, wherein the body extends rearward from the front plate and the flat medial surface extends downwards and forwards past the front plate.

3. The hopper of claim 2, wherein the body has a U-shape comprising a plurality of discrete flat surfaces.

4. The hopper of claim 2, further comprising a bottom plate, the bottom plate being positioned at an end of the flat medial surface, wherein a transition between the flat medial surface and the bottom plate is forwards of the front plate.

5. The hopper of claim 4, wherein the bottom plate is oriented at an angle of at least 20 degrees relative to the flat medial surface.

6. The hopper of claim 4, wherein the bottom plate is manufactured from a material comprising a nominal hardness of at least 400 Brinell Hardness Number.

7. The hopper of claim 2, wherein the body further comprises an accessory bar positioned on an exterior surface of the body on a side of the body opposite the front plate, the accessory bar comprising a plurality of light emitting devices or a camera.

8. A mixer vehicle comprising:
a chassis;
a mixer assembly coupled with the chassis, the mixer assembly comprising a mixer drum; and
a hopper configured to direct material into the mixer drum, the hopper comprising:
a body defining a flat medial surface for transfer of material into the mixer drum of the mixer vehicle, the flat medial surface being angled 45 degrees or less relative to a vertical axis.

9. The mixer vehicle of claim 8, wherein the hopper further comprises a front plate, the front plate extending vertically along the vertical axis, wherein the body extends rearward from the front plate and the flat medial surface extends downwards and forwards past the front plate.

10. The mixer vehicle of claim 9, wherein the body has a U-shape comprising a plurality of discrete flat surfaces.

11. The mixer vehicle of claim 9, wherein the hopper further comprises a bottom plate, the bottom plate being positioned at an end of the flat medial surface, wherein a transition between the flat medial surface and the bottom plate is forwards of the front plate.

12. The mixer vehicle of claim 11, wherein the bottom plate is oriented at an angle of at least 20 degrees relative to the flat medial surface.

13. The mixer vehicle of claim 11, wherein the bottom plate is manufactured from a material comprising a nominal hardness of at least 400 Brinell Hardness Number.

14. The mixer vehicle of claim 9, wherein the body further comprises an accessory bar positioned on an exterior surface of the body on a side of the body opposite the front plate, the accessory bar comprising a plurality of light emitting devices or a camera.

15. A hopper for a mixer vehicle, the hopper comprising:
a body defining a flat medial surface for transfer of material into a mixer drum of the mixer vehicle, the flat medial surface being angled 45 degrees or less relative to a vertical axis; and
a front plate extending vertically along the vertical axis, wherein the body extends rearward from the front plate and the flat medial surface extends downwards and forwards past the front plate.

16. The hopper of claim 15, wherein the body has a U-shape comprising a plurality of discrete flat surfaces.

17. The hopper of claim 16, further comprising a bottom plate, the bottom plate being positioned at an end of the flat medial surface, wherein a transition between the flat medial surface and the bottom plate is forwards of the front plate.

18. The hopper of claim 17, wherein the bottom plate is oriented at an angle of at least 20 degrees relative to the flat medial surface.

19. The hopper of claim 17, wherein the bottom plate is manufactured from a material comprising a nominal hardness of at least 400 Brinell Hardness Number.

20. The hopper of claim 16, wherein the body further comprises an accessory bar positioned on an exterior surface of the body on a side of the body opposite the front plate, the accessory bar comprising a plurality of light emitting devices or a camera.
